(19) United States
(12) Patent Application Publication
(10) Pub. No.: US 2024/0110493 A1
(43) Pub. Date: Apr. 4, 2024

(54) ROLLER PIN DECOUPLING TYPE CDA SYSTEM

(71) Applicants: Hyundai Motor Company, Seoul (KR); Kia Corporation, Seoul (KR)

(72) Inventor: SEUNG-WOO SHIN, Hwaseong-si (KR)

(21) Appl. No.: 18/325,522

(22) Filed: May 30, 2023

(30) Foreign Application Priority Data
Oct. 4, 2022 (KR) 1020220126047

(51) Int. Cl. F01L 13/00; F01L 1/26

(52) U.S. Cl. CPC F01L 13/0005; F01L 1/267; F01L 1/18; F01L 2013/001

(57) ABSTRACT

A roller pin decoupling type cylinder deactivation (CDA) system includes a roller rocker arm, rocker shaft, a camshaft, and an actuation valve. When oil is not supplied to a rocker shaft sub passage of the rocker shaft and a hydraulic pressure is released from the actuation valve, the roller and the pin are not restrained so that the CDA is generated. Thus, the roller is switched to a non-rotating state and a rotating state according to non-operation and operation of the CDA. In particular, a degree of freedom of control over a system mechanism is imparted due to restriction control of the roller pin through the actuation valve which is operated by a hydraulic pressure, which makes it possible to improve operation efficiency for each engine operating condition.

### CROSS-REFERENCE(S) TO RELATED APPLICATIONS

This application claims priority to Korean Patent Application No. 10-2022-0126047, filed on Oct. 4, 2022, which is incorporated herein by reference in its entirety.

### TECHNICAL FIELD

Exemplary implementations of the present disclosure relate to a cylinder deactivation (CDA) system, and particularly, to a decoupling type CDA system in which a roller and a pin of a roller rocker arm are fixed to and separated from each other through a hydraulic pressure so that a degree of freedom of control is given when compared to a fixed type system.

### BACKGROUND

Generally, a cylinder deactivation (CDA) system is installed on each cylinder of an engine and switches a cylinder, which is a corresponding cylinder, to an idle state using a roller rocker arm operated by a hydraulic pressure supplied during a CDA operation.

To this end, the CDA system employs a rocker arm device in connection with to a valve device, and the rocker arm device includes a roller rocker arm, a rocker pin positioned inside a rocker arm mechanism, an oil control valve (OCV) configured to control an oil supply to the rocker pin from the outside of the roller rocker arm, and a roller configured to follow a cam profile of a camshaft.

For example, when the rocker pin is operated by a hydraulic pressure, a motion of the roller is changed along the cam profile of a cam provided on the camshaft so that the roller rocker arm allows a corresponding cylinder to be switched to an idle cylinder through operating and stopping of a CDA.

That is, in the rocker arm device, a movement of the roller along the cam profile lowers an end of the roller rocker arm (that is, a portion of a screw side) opposite to the rocker shaft toward a valve bridge of the valve device, and this movement presses downward the valve bridge so that valve driving generally performs pressing.

However, the rocker arm device is performed in such a way that the roller operating the roller rocker arm by its movement along the cam profile always maintains a non-rotating state (i.e., a fixed state) regardless of whether the CDA is operated. In this case, the roller performs the CDA action by forming a gap with the cam.

Therefore, there is no degree of freedom of control in a state in which mechanisms (e.g., the roller and the pin) in the system comprising the rocker arm device are fixed, and this limitation of the degree of freedom of control inevitably makes it impossible to improve operating efficiency for each engine operating condition.

### SUMMARY OF PRESENT DISCLOSURE

An implementation of the present disclosure is directed to a roller pin decoupling type cylinder deactivation (CDA) system, in which a pin serving as a rotating shaft of a roller in a state in which the pin is coupled to a roller rocker arm, is fixed to and separated from the roller through a hydraulic pressure, and thus the roller is switched to a non-rotating state and a rotating state according to a non-operation and an operation of a CDA, and particularly, which is capable of improving operating efficiency for each engine operating condition by imparting a degree of freedom of control with respect to a system mechanism by means of restraint control of the pin through an actuation valve which operates by a hydraulic pressure.

In accordance with an implementation of the present disclosure, there is provided a cylinder deactivation (CDA) system including a roller rocker arm, a rocker shaft, a camshaft, and an actuation valve, wherein when oil is not supplied to a rocker shaft sub passage of the rocker shaft and a hydraulic pressure is released from the actuation valve, the roller and the pin are not restrained so that the CDA is generated.

As an exemplary implementation, the roller rocker arm may be moved along a cam profile of a cam to generate a valve lift of a CDA operation; the roller may be brought into contact with the cam profile and may be coupled to a pin fixed to one end portion of the roller rocker arm; and the actuation valve may form a roller unlocking status in which the roller and the pin are separated from each other through a hydraulic release of the oil upon operation of the CDA, and may form a roller locking status in which the roller and the pin are fixed from each other through hydraulic formation upon non-operation of the CDA.

As an exemplary implementation, the actuation valve may include a locking-type actuation valve configured to form the roller locking status by being fitted into a piston groove recessed into an inner diameter of the roller; or a pressurizing-type actuation valve configured to form the roller locking status by being brought into close contact with the inner diameter of the roller.

As an exemplary implementation, the locking-type actuation valve or the pressurizing-type actuation valve may be installed on the roller pin.

As an exemplary implementation, the locking-type actuation valve may include a valve housing in which the pin is embedded and an oil inlet into which the oil is introduced is formed; a locking piston provided with a linear rod inserted into the piston groove; an O-ring configured to form airtightness between the valve housing and the linear rod; a return spring configured to elastically support the locking piston; and a ball configured to block the oil inlet with spring elasticity of the return spring.

As an exemplary implementation, the locking piston of the locking-type actuation valve may have a “T”-shaped body with a head formed on the linear rod and configured to support the ball using a ball seating groove.

As an exemplary implementation, the pressurizing-type actuation valve may include a valve housing in which the pin is embedded and an oil inlet into which the oil is introduced is formed; a contact piston provided with a rounded contact portion which is brought into close contact with the inner diameter of the roller; an O-ring configured to form airtightness between the valve housing and the rounded contact portion; a return spring configured to elastically support the contact piston; and a ball configured to block the oil inlet with spring elasticity of the return spring.

As an exemplary implementation, the contact piston of the pressurizing-type actuation valve may have a “T”-shaped body with a head formed on the rounded contact portion and configured to support the ball using a ball seating groove.

As an exemplary implementation, a coupling of the roller and the pin may become in a separated state in which the roller is freely rotated along the cam profile, the separated state may be set by a lash through a diameter difference between the inner diameter of the roller and an outer diameter of the pin; and the lash may be set by a rocker ratio to the inner diameter of the roller which do not interfere with the pin in a state in which the roller is rotated only without following the cam profile.

As an exemplary implementation, the hydraulic formation and the hydraulic release may be achieved by supplying and blocking the oil through the rocker shaft sub passage; and the rocker shaft sub passage may be connected from the roller rocker arm to the actuation valve through the pin.

As an exemplary implementation, the rocker shaft sub passage may include a rocker arm line and a roller pin line; the rocker arm line may be formed in the roller rocker arm; and the roller pin line may be connected between the rocker arm line and the actuation valve through an inside of the pin.

As an exemplary implementation, the rocker shaft sub passage may be connected to a rocker shaft main passage which is switched from the roller rocker arm to an oil control valve (OCV), the OCV may be controlled by a controller, and the controller may control the OCV to open the rocker shaft sub passage upon the non-operation of the CDA and may control the OCV to close the rocker shaft sub passage upon the operation of the CDA.

As an exemplary implementation, upon the non-operation of the CDA, the controller may operate the OCV, operate the actuation valve by a hydraulic action generated through a supply of the oil to the rocker shaft sub passage by the OCV, and generate the roller locking status by operating the actuation valve so that the valve lift may be generated.

As an exemplary implementation, upon the operation of the CDA, the controller may stop the operation of the OCV, stop the operation of the actuation valve by the hydraulic release generated through a supply stop of the oil to the rocker shaft sub passage by the OCV, generate a lost motion in the roller rocker arm by forming the roller unlocking status due to the non-operation of the actuation valve, and generate no valve lift due to the lost motion.

### BRIEF DESCRIPTION OF THE DRAWINGS

FIG. 1 is a configurational diagram illustrating a roller pin decoupling type cylinder deactivation (CDA) system according to the present disclosure.

FIG. 2 is a diagram illustrating a layout example of a rocker shaft sub passage and an actuation valve according to the present disclosure.

FIG. 3 is a diagram illustrating a state in which a roller and a pin are fixed to each other through the actuation valve during a CDA operation of the roller pin decoupling type CDA system according to the present disclosure.

FIG. 4 is a diagram illustrating a state in which the roller and the pin are separated from each other through the actuation valve during the CDA operation of the roller pin decoupling type CDA system according to the present disclosure.

### DESCRIPTION OF SPECIFIC IMPLEMENTATIONS

Exemplary implementations of the present disclosure will be described below in detail with reference to the accompanying drawings. These implementations are examples of the present disclosure and may be implemented in various different forms by those skilled in the art to which the present disclosure pertains. Therefore, the present disclosure is not limited to these implementations.

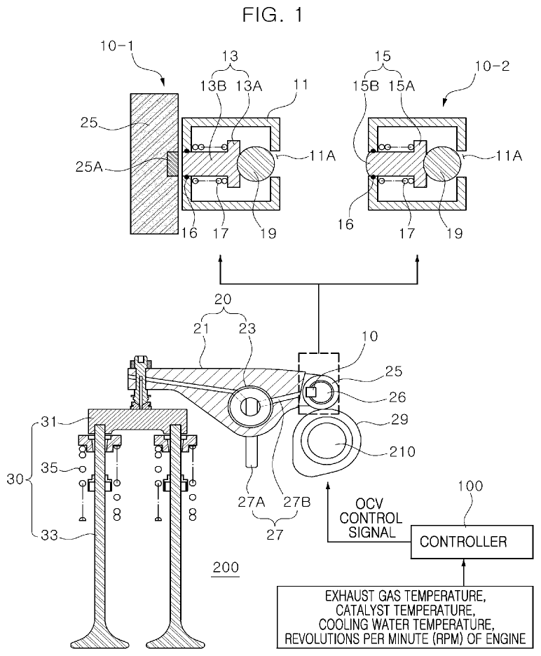

Referring to FIG. 1, a cylinder deactivation (CDA) system 1 includes a roller rocker arm 21, a rocker shaft 23, a camshaft 210, and an actuation valve 10. In terms of an operation of the CDA system 1, the CDA system 1 is characterized in that, when oil is not supplied to a rocker shaft sub passage 27B of the rocker shaft 23 and a hydraulic pressure is released from the actuation valve 10, a roller 25 and a roller pin 26 are not restrained and the CDA is generated. In this case, the CDA means a cylinder idle state of an engine 200.

In particular, upon non-operation of the CDA, the actuation valve 10 removes a free rotation of the roller 25, moves the roller rocker arm 21 along a cam profile (or a cam lobe) of a cam 29, and fixes the roller pin 26 and the roller 25 to generate a valve lift of a valve device 30. On the other hands, upon operation of the CDA, the roller 25 allows the roller rocker arm 21 not to follow the cam profile (or the cam lobe) of the cam 29 but to be rotated only to separate the pin 26 from the roller 25, thereby preventing a valve lift of the valve device 30 from being generated.

Therefore, the CDA system 1 is characterized by a roller pin decoupling type CDA system in which a hydraulic action of the actuation valve 10 moves the pin 26 between the non-operation and the operation of the CDA so that the roller 25 is fixed (i.e., a non-operating state of the CDA) or separated (i.e., an operating state of the CDA).

Specifically, according to a manner of fixing the actuation valve 10 to the roller 25, the actuation valve 10 is classified into a locking-type actuation valve 10-1 and a pressurizing-type actuation valve 10-2.

For example, the locking-type actuation valve 10-1 includes a valve housing 11, a locking piston 13, an O-ring 16, a return spring 17, and a ball 19, and the locking piston 13 protrudes from the pin 26 by a hydraulic action and is fitted into a piston groove 25A of the roller 25 so that a fixed state of the pin 26 and the roller 25 is formed.

To this end, the valve housing 11 has an inner space into which oil flows, and is fixedly inserted into the pin 26, the locking piston 13 receives the hydraulic action (i.e., an oil pressure) of the oil filling the inner space of the valve housing 11 and is fitted into the piston groove 25A of the roller 25, the O-ring 16 forms airtightness with respect to the locking piston 13, the return spring 17 elastically supports the locking piston 13 in the inner space of the valve housing 11, and when a pressure of the oil supplied through the rocker shaft sub passage 27B of a rocker arm oil line 27 of the roller rocker arm 21 is greater than an elastic force of the return spring 17, the ball 19 opens an oil inlet 11A of the valve housing 11. In this case, a coil spring is applied to the return spring 17.

In particular, a “-” shaped vertical head 13A of a “T”-shaped body of the locking piston 13 stably maintains a support state of the ball 19 using a hemispherical ball seating groove and receives the pressure of the oil filling the inner space of the valve housing 11, and an “I”-shaped horizontal linear rod 13B of the “T”-shaped body of the locking piston 13 is moved toward the piston groove 25A of the roller 25 while compressing the return spring 17 due to the hydraulic action of the oil, thereby being fitted into the piston groove 25A of the roller 25.

In addition, the O-ring 16 is positioned at a piston outlet of the valve housing 11 (that is, a portion opposite to the oil inlet 11A) from which the horizontal rod of the locking piston 13 exits, thereby performing a sealing action with respect to the inner space of the valve housing 11 when the locking piston 13 is moved forward and backward.

For example, the pressurizing-type actuation valve 10-2 includes the valve housing 11 in which the oil inlet 11A is formed, a contact piston 15, the O-ring 16, the return spring 17, and the ball 19, and the contact piston 15 protrudes from the pin 26 by the hydraulic action of the oil supplied through the rocker shaft sub passage 27B of the rocker arm oil line 27 of the roller rocker arm 21 and pressurizes the roller 25 in a state of being close brought into contact with an inner diameter of the roller 25, thereby forming a fixed state of the pin 26 and the roller 25. In this case, the inner diameter of the roller 25 is a space in which the pin 26 is inserted.

For example, the valve housing 11, the O-ring 16, the return spring 17, and the ball 19 are the same components as the locking-type actuation valve 10-1.

However, a “-”-shaped vertical head 15A of a “T”-shaped body of the contact piston 15 stably maintains a support state of the ball 19 using a hemispherical ball seating groove, and receives a pressure of the oil filling the inner space of the valve housing 11, and a “D”-shaped rounded contact portion 15B of the “T”-shaped body of the contact piston 15 is formed to form a large contact surface with the inner diameter of the roller 25. In this case, a curvature of the arc-shaped contact surface is formed to be the same as a curvature of the inner diameter of the roller 25.

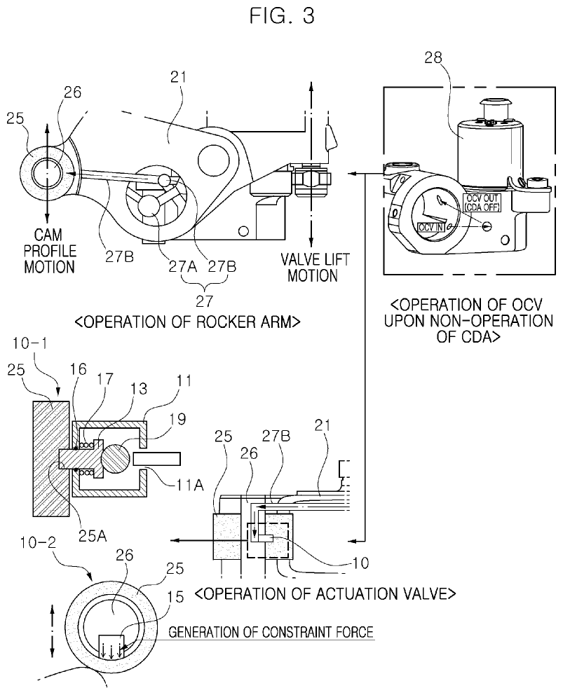

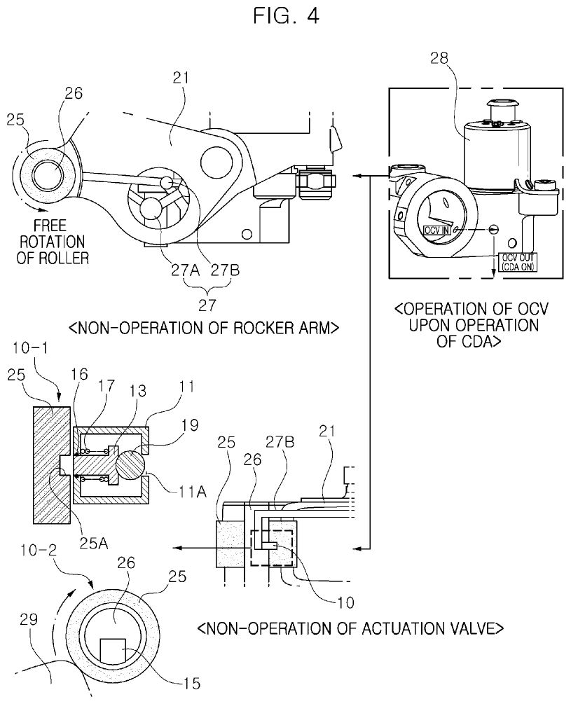

Specifically, the rocker arm device 20 includes the roller rocker arm 21, the rocker shaft 23, the roller 25, the pin 26, the rocker arm oil line 27, an oil control valve (OCV) 28 (see FIGS. 3 and 4), and the cam 29.

For example, the roller rocker arm 21 is mounted on the engine 200 (i.e., a cylinder head) and controls generation of a valve lift by a seesaw motion (i.e., rotations in clockwise and counterclockwise directions) based on the rocker shaft 23 through a motion of the roller along the cam profile in a state of being brought into contact with the roller and the cam 29.

For example, in the rocker shaft 23, the rocker arm oil line 27 controlled by the OCV 28 is formed in a rocker arm shaft, and the rocker shaft 23 passes through the roller rocker arm 21 in a parallel arrangement with the camshaft 210 of the engine 200 and thus serves as a rotation center of the roller rocker arm 21 in the clockwise and counterclockwise directions.

For example, the roller 25 is coupled to one end of the roller rocker arm 21 (i.e., a portion toward the cam 29) using the pin 26 to be brought into contact with the cam profile (or the cam lobe) of the cam 29, the roller 25 moves the roller rocker arm 21 along the cam profile (or the cam lobe) so as to generate a valve lift of the valve device 30 when fixed to the pin 26 during the operation of the actuation valve 10 through the locking piston 13 or the contact piston 15, or when separated from the pin 26, the roller 25 is rotated only without following the cam profile (or the cam lobe) so as not to generate the valve lift of the valve device 30. In this case, the roller 25 is formed as a hollow shaft.

In particular, the piston groove 25A is formed on the inner diameter of the roller at a position facing the locking piston 13, so that a structural change suitable for the locking-type actuation valve 10-1 is achieved.

For example, the pin 26 passes through the inner diameter of the roller 25 in a state of being fixed to one end portion of the roller rocker arm 21, and the valve housing 11 or the contact piston 15 is coupled to an outer diameter of the roller pin so that the actuation valve 10 is mounted in a state of facing the inner diameter of the roller 25. In this case, the pin 26 is formed as a real shaft.

In particular, the roller 25 and the pin 26 set a sufficient lash and a rocker ratio to the inner diameter of the roller due to a difference in diameter between the inner diameter of the roller 25 and the outer diameter of the pin 26. In this case, the lash is necessary to prevent the roller 25 from interfering with the pin 26 in a state in which the roller 25 is freely rotated, and the rocker ratio to the inner diameter of the roller is necessary to prevent the pin 26 from being directly affected by the cam profile (the cam lobe) in the free rotation state in which the roller 25 is rotated only without following the cam profile (the cam lobe).

For example, the rocker arm oil line 27 includes a rocker shaft main passage 27A and the rocker shaft sub passage 27B, in which an oil supply is controlled by opening and closing the OCV 28, the rocker shaft main passage 27A is connected to an inside of the rocker shaft 23 and supplies the oil from one end of the roller rocker arm 21 (i.e., in a direction opposite to the roller 25) to a variable mechanism in contact with a valve bridge 31, thereby generating a valve lift by the roller rocker arm 21, and the rocker shaft sub passage 27B branches from the rocker shaft main passage 27A and supplies the oil to the actuation valve 10 from the other end of the roller rocker arm 21 (i.e., in a direction toward the roller 25) through the pin 26. In this case, the oil is engine oil supplied from a main gallery of the engine 200.

For example, in a rocker arm body of the roller rocker arm 21, the OCV 28 switches oil paths of the rocker shaft main passage 27A and the rocker shaft sub passage 27B, thereby supplying the oil to one end portion of the roller rocker arm 21 (i.e., the variable mechanism in a direction opposite to the roller 25) through the rocker shaft main passage 27A or supplying the oil to the other end of the roller rocker arm 21 (i.e., the actuation valve 10 in the direction of the roller 25). In this case, the OCV 28 discharges the oil, which is supplied through an oil return line, from the actuation valve 10 and the roller rocker arm 21.

For example, the cam 29 has the cam profile (the cam lobe) with which the roller is brought into contact and is coupled to the camshaft 210 of the engine 200.

Specifically, the valve device 30 includes the valve bridge 31, an exhaust valve 33, and a valve spring 35.

For example, the valve bridge 31 is brought into contact with one end of the roller rocker arm 21 (i.e., the variable mechanism in a direction opposite to the roller 25) so that upon the non-operation of the CDA, the movement of the roller rocker arm 21 is transmitted to the variable mechanism to generate a valve lift of the exhaust valve 33.

For example, the exhaust valve 33 includes two valves of a left exhaust valve and a right exhaust valve, which are coupled to the valve bridge 31 with an interval from each other, and the valve spring 35 is coupled to each of the left and right exhaust valves to provide spring elasticity when the valves are returned. In this case, a coil spring is applied to the valve spring 35.

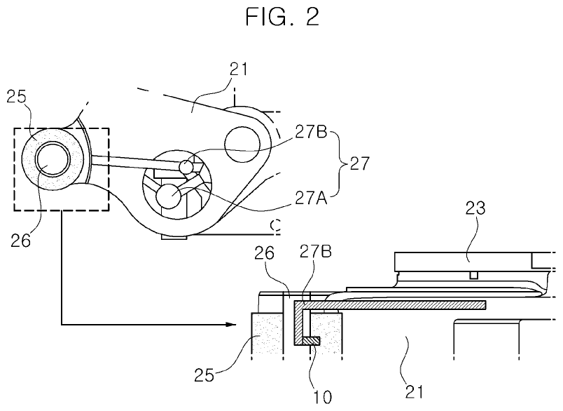

Specifically, a controller 100 controls the opening and closing of the OCV 28 to form an oil supply and blocking circuit with respect to the rocker shaft main passage 27A and the rocker shaft sub passage 27B of the rocker arm oil line 27. To this end, the controller 100 generates CDA ON/OFF information based on a vehicle driving condition or an engine control status and controls the OCV 28 using an OCV control signal (or a CDA ON/CDA OFF signal output) according to whether CDA control is performed. In this case, the controller 100 may be a separate dedicated controller or an engine controller. Meanwhile, referring to FIG. 2, a layout of the rocker shaft sub passage 27B may be formed as a rocker arm line and a roller pin line.

For example, the rocker arm line is formed in a straight line shape connected from the rocker shaft 23 to the other end of the rocker arm (i.e., the direction toward the roller 25) along the rocker arm body of the roller rocker arm 21, and the roller pin line is formed in a l″ shape by being recessed into the pin 26 so that one end thereof is connected to the rocker arm line and the other end thereof is connected to the oil inlet 11A of the valve housing 11 of the actuation valve 10 or a piston chamber 26A of the pin 26.

Therefore, the rocker shaft sub passage 27B supplies the oil to the actuation valve through switching of the oil flow path of the OCV 28 under the control of the controller 100.

Meanwhile, FIGS. 3 and 4 show the operating state of the actuation valve 10 according to the operation and non-operation of the CDA of the roller rocker arm 21.

Referring to the non-operation of the CDA in FIG. 3, the OCV 28 starts to be operated in response to an OCV control signal output (i.e., a CDA OFF signal) of the controller 100. In this case, the controller 100 determines the valve lift of the exhaust valve 33 for the CDA from engine data, such as an exhaust gas temperature, a catalyst temperature, a cooling water temperature, and an engine rotation speed, according to the operation of engine 200, and this is a basic operating method of the CDA system 1.

Then, the OCV 28 opens the rocker shaft sub passage 27B through the switching of the rocker shaft main passage 27A so that the rocker shaft sub passage 27B supplies the oil sent from the main gallery of the engine 200 to the actuation valve 10.

Consequently, the actuation valve 10 allows the ball 19 to open the oil inlet 11A of the valve housing 11 due to the pressure of the oil filling the rocker shaft sub passage 27B. The locking piston 13 exits the inner space while compressing the return spring 17 due to the hydraulic action of the oil filling the inner space of the valve housing 11, and thus protrudes from the outer diameter of pin 26. Thereafter, the locking piston 13 enters the piston groove 25A of roller 25 and is fitted thereinto so that the pin 26 and the roller are in a fixed state or the contact piston 15 is brought into contact with the inner diameter of the roller 25 to form a pressurized state so that the pin 26 and the roller 25 are in the fixed state.

That is, in the case of the locking-type actuation valve 10-1 of the actuation valve 10, the “I”-shaped horizontal linear rod 13B of the “T”-shaped body of the locking piston 13 is fitted into the piston groove 25A of the roller 25 so that the pin 26 and the roller 25 are in the fixed state. On the other hand, in the case of the pressurizing-type actuation valve 10-2, the “D”-shaped rounded contact portion 15B of the “T”-shaped body of the contact piston 15 is brought into contact with the inner diameter of the roller 25 to form a pressurized state so that the pin 26 and the roller 25 are in the fixed state.

In this way, the roller 25 generates a cam profile motion following the cam profile (or the cam lobe) of the cam 29 without the free rotation in the roller locking status, and the roller rocker arm 21 presses the valve bridge 31 with the valve lift motion by the roller 25 at one end portion of the rocker arm (i.e., in a direction opposite to the roller 25) about the rocker shaft 23 as a rotation center so that the valve lift of the exhaust valve 33 is generated.

In this way, upon the non-operation of the CDA, the CDA system 1 operates in order of (1) the operation of the OCV valve→(2) the oil supply to a sub passage of the rocker shaft→(3) the operation of the actuation valve→(4) roller locking→(5) the generation of the valve lift. In this case, “→” indicates the order of operation.

On the other hand, referring to the operation of the CDA in FIG. 4, the operation of the OCV 28 is stopped in response to a stop of the OCV control signal output from the controller 100 (i.e., the CDA ON signal) and opens the rocker shaft main passage 27A through the switching of the rocker shaft sub passage 27B so that the oil sent from the main gallery of the engine 200 flows only into the rocker shaft main passage 27A. Thus, the actuation valve 10 is switched to a state in which the oil supply through the rocker shaft sub passage 27B is not present.

Consequently, the actuation valve 10 is returned to its original position by receiving a spring restoring force of the return spring 17 in a state in which the locking piston 13 is in a hydraulic release state and protrudes from the piston groove 25A of the roller 25 or the contact piston 15 of the actuation valve 10 is separated from the roller 25, and the oil inlet 11A of the valve housing 11 is blocked again by the ball 19 moving together with the locking piston 13, and then the locking piston 13 or the contact piston 15 is completely returned to the inner space of the valve housing 11, so that the pin 26 and the roller 25 are switched to the separated state again.

That is, in the case of the locking-type actuation valve 10-1 of the actuation valve 10, the “I”-shaped horizontal linear rod 13B of the “T”-shaped body of the locking piston 13 completely exits from the piston groove 25A of the roller 25 so that the pin 26 and the roller 25 are switched to a separated state. On the other hand, in the case of the pressurizing-type actuation valve 10-2, the “D”-shaped rounded contact portion 15B of the “T”-shaped body of the contact piston 15 forms a non-contact state with the inner diameter of the roller 25 so that the pin 26 and the roller 25 are switched to the separated state.

In this way, the roller 25 is freely rotated only without following the cam profile (or the cam lobe) of cam 29 in a roller unlocking status, and the roller rocker arm 21 cannot press the valve bridge 31 due to a lost motion by the roller 25, thereby preventing the valve lift of the exhaust valve 33 from being generated.

In this way, upon the operation of the CDA, the CDA system 1 operates in order of (1) the non-operation of the OCV valve→(2) no oil supply to the sub passage of the rocker shaft→(3) the non-operation of the actuation valve→(4) roller unlocking→(5) the generation of the lost motion→(6) the non-generation of the valve lift. In this case, “→” indicates the order of operation.

As described above, in accordance with the roller pin decoupling type cylinder deactivation (CDA) system 1 according to the present implementation, upon non-operation of the CDA, the roller 25 coupled to the pin 26 fixed to one end portion of the roller rocker arm 21, which generates a valve lift of the valve device 30 as a movement according to the cam profile of the cam 29, generates a valve lift in a roller locking status, whereas, upon operation of the CDA, the actuation valve 10, which does not generate a valve lift in a roller unlocking status, is included so that roller 25 is switched to a non-rotating state and a rotating state according to the non-operation and operation of the CDA. In particular, due to restriction control of the roller pin through the actuation valve 10 which is operated by a hydraulic pressure, a degree of freedom of control over a system mechanism is imparted, which makes it possible to improve operation efficiency for each engine operating condition.

A roller pin decoupling type cylinder deactivation (CDA) system of the present disclosure implements the following actions and effects.

First, a pin serving as a rotation shaft of a roller moving a roller rocker arm is fixed to and separated from a roller between non-operation and operation of the CDA so that the CDA system can be formed in a decoupling structure having a degree of freedom of control higher than a fixed structure. Second, a hydraulic actuation valve is used under restraint control of a roller pin, and thus an oil circuit of the roller rocker arm is directly used so that a structural change of the roller rocker arm can be minimized. Third, by imparting the degree of freedom of control over the system mechanism through the fixing and separating of the roller and the pin, operation efficiency can be improved for each engine operating condition. Fourth, by implementing a cylinder idle function of the CDA for each engine operating condition, a temperature increase technology for improving post-treatment performance according to strengthening of exhaust regulations can be greatly improved.

While the present disclosure has been described with reference to the accompanying drawings, it will be apparent to those skilled in the art that various changes and modifications can be made without departing from the spirit and scope of the present disclosure without being limited to the exemplary implementations disclosed herein. Accordingly, it should be noted that such alternations or modifications fall within the claims of the present disclosure, and the scope of the present disclosure should be construed on the basis of the appended claims.

What is claimed is:

1. A cylinder deactivation (CDA) system, comprising:
a roller rocker arm;
a rocker shaft connected to the roller rocker arm;
a rocker shaft sub passage configured to supply oil to the rocker shaft;
a roller pin disposed at the roller rocker arm;
a roller configured to rotate about the roller pin;
a cam in contact with the roller; and
an actuation valve configured to, based on stopping supply of the oil through the rocker shaft sub passage, release a hydraulic pressure in the rocker shaft sub passage and release a restraint between the roller and the roller pin to thereby enable CDA.

2. The CDA system of claim 1, wherein the cam defines a cam profile in contact with the roller,
wherein the roller rocker arm is configured to, based on the roller moving along the cam profile, generate a valve lift operation of a cylinder valve,
wherein the roller is coupled to the roller pin, the roller pin being fixed to one end portion of the roller rocker arm, and
wherein the actuation valve is configured to:
generate a roller unlocking status in which the roller and the roller pin are separated from each other by releasing the hydraulic pressure for operation of the CDA, and
generate a roller locking status in which the roller and the roller pin are fixed to each other by applying the hydraulic pressure for a non-operation of the CDA.

3. The CDA system of claim 2, wherein the actuation valve comprises:
a locking-type actuation valve configured to insert into a piston groove recessed from an inner surface of the roller to thereby generate the roller locking status, or
a pressurizing-type actuation valve configured to contact the inner surface of the roller to thereby generate the roller locking status.

4. The CDA system of claim 3, wherein the locking-type actuation valve or the pressurizing-type actuation valve is installed at the roller pin.

5. The CDA system of claim 3, wherein the locking-type actuation valve comprises:
a valve housing that accommodates the roller pin and defines an oil inlet configured to introduce the oil;
a locking piston comprising a linear rod, the linear rod being configured to insert into the piston groove;
an O-ring configured to provide airtightness between the valve housing and the linear rod;
a return spring configured to elastically support the locking piston; and
a ball configured to block the oil inlet by spring elasticity of the return spring.

6. The CDA system of claim 5, wherein the locking piston further comprises a head that is disposed at an end of the linear rod and defines a ball seating groove configured to support the ball, wherein the linear rod and the head define a T-shaped body.

7. The CDA system of claim 3, wherein the pressurizing-type actuation valve comprises:
a valve housing that accommodates the roller pin and defines an oil inlet configured to introduce the oil;
a contact piston that defines a rounded contact portion configured to contact the inner surface of the roller;
an O-ring configured to provide airtightness between the valve housing and the rounded contact portion;
a return spring configured to elastically support the contact piston; and
a ball configured to block the oil inlet by spring elasticity of the return spring.

8. The CDA system of claim 7, wherein the contact piston comprises a head that is disposed at the rounded contact portion and defines a ball seating groove configured to support the ball, wherein the rounded contact portion and the head define a T-shaped body.

9. The CDA system of claim 2, wherein the roller and the roller pin are rotatably coupled to each other in a state in which the roller freely rotates along the cam profile.

10. The CDA system of claim 9, wherein the roller and the roller pin are configured to be in a separated state by a gap defined by a diameter difference between an inner diameter of the roller and an outer diameter of the roller pin, and
wherein the gap is set by the inner diameter of the roller and a rocker ratio such that the roller does not interfere with the roller pin and rotates without following the cam profile.

11. The CDA system of claim 2, wherein the actuation valve is configured to:
generate the hydraulic pressure by supplying the oil through the rocker shaft sub passage; and
release the hydraulic pressure by blocking the rocker shaft sub passage, and
wherein the rocker shaft sub passage connects the roller rocker arm to the actuation valve through the roller pin.

12. The CDA system of claim 11, wherein the rocker shaft sub passage comprises:
a rocker arm line defined in the roller rocker arm; and
a roller pin line that connects between the rocker arm line and the actuation valve through an inside of the roller pin.

13. The CDA system of claim 11, further comprising an oil control valve (OCV),
wherein the rocker shaft sub passage is connected to a rocker shaft main passage at the roller rocker arm.

14. The CDA system of claim 13, further comprising a controller configured to control the OCV, and
wherein the controller is configured to:
control the OCV to open the rocker shaft sub passage based on the non-operation of the CDA, and
control the OCV to close the rocker shaft sub passage based on the operation of the CDA.

15. The CDA system of claim 14, wherein, based on the non-operation of the CDA, the controller is configured to:
operate the OCV;
operate the actuation valve by a hydraulic action generated through a supply of the oil to the rocker shaft sub passage by the OCV; and
generate the roller locking status by an operation of the actuation valve to thereby generate the valve lift operation.

16. The CDA system of claim 14, wherein, based on the operation of the CDA, the controller is configured to:
stop operation of the OCV;
stop the operation of the actuation valve by a hydraulic release generated through a supply stop of the oil to the rocker shaft sub passage by the OCV; and
generate a lost motion in the roller rocker arm by generating the roller unlocking status via a non-operation of the actuation valve, the lost motion resulting in no valve lift operation of the cylinder valve.
